(19) United States
(12) Patent Application Publication
(10) Pub. No.: US 2021/0337370 A1
(43) Pub. Date: Oct. 28, 2021

(54) MONITORING METHOD AND SYSTEM BASED ON TERMINAL DETECTION

(71) Applicant: The Ambition Technology Limited, Shenzhen (CN)

(72) Inventor: Bo Peng, Shenzhen (CN)

(21) Appl. No.: 17/369,938

(22) Filed: Jul. 7, 2021

Related U.S. Application Data
(63) Continuation of application No. PCT/CN2020/071241, filed on Jan. 9, 2020.

(30) Foreign Application Priority Data
Jan. 14, 2019 (CN) 201910031207.8

(51) Int. Cl. H04W 4/90; H04W 4/029; H04W 4/02; H04W 4/80; H04W 64/00; H04W 80/02

(52) U.S. Cl. CPC H04W 4/90; H04W 4/029; H04W 4/027; H04W 84/12; H04W 64/006; H04W 80/02; H04W 4/80

(57) ABSTRACT

A monitoring method and system based on terminal detection are provided. The method has the following steps: detecting, in real time, Bluetooth signals, and/or WiFi signals, and/or terminal frequencies in a detection area, and obtaining terminal MAC addresses, and/or Bluetooth MAC addresses, and/or WiFi MAC addresses, and/or the terminal frequencies; compiling statistics of the numbers of received terminal MAC addresses, and/or received Bluetooth MAC addresses, and/or received WiFi MAC addresses, and/or received terminal frequencies so as to obtain number information of terminals in the detection area, determining position information of the terminals according to the detection area, and estimating number information and position information of trapped persons according to the number information and the position information of the terminals; and sending, in real time, the number information and the position information of the trapped persons to a safety director or the rescue worker.

### CROSS REFERENCE TO RELATED APPLICATIONS

The present application is a Continuation Application of PCT Application No. PCT/CN2020/071241 filed on Jan. 9, 2020, which claims the benefit of Chinese Patent Application No. 201910031207.8 filed on Jan. 14, 2019. All the above are hereby incorporated by reference in their entirety.

### TECHNICAL FIELD

The present disclosure relates generally to a communication technical field, and more particularly, relates to a monitoring method and a monitoring system based on terminal detection.

### BACKGROUND

In recent years, accidents occur frequently all over the whole country. For example, fires in office buildings, shopping malls and other modern buildings will cause huge property losses and casualties. At present, the existing alarm system usually carries out the fire monitoring and alarming function through monitoring the fire and generating the fire alarm signal by the smoke sensor and temperature sensor, and uploading the fire alarm signal to the remote monitoring terminal.

However, the above-mentioned alarm system can not effectively indicate the number and position information of the trapped people at the rescue site, so it can not provide the accurate fire alarm information for a third-party public platform, such as the fire department to formulate the rescue plan, thus can not effectively guide the rescue worker to search and rescue the trapped people at the rescue site, resulting in the low rescue speed and efficiency. Therefore, how to monitor the number and position information of the trapped personnel at the rescue site in real time, so as to implement the on-site control and rescue, reduce the rescue risk, and ensure the personal safety of the trapped personnel and the rescue worker, is a crucial issue.

### SUMMARY

The object of the present application is to provide a monitoring method and a monitoring system based on terminal detection for improving the speed and efficiency of the on-site rescue, aiming at the above problems mentioned in the existing alarm system of the low rescue speed and efficiency.

In a first aspect, a monitoring method based on terminal detection is provided, which comprising following steps:

detecting, in real time, a Bluetooth signal, and/or a WiFi signal, and/or a terminal frequency in a detection area, and obtaining a terminal MAC address, and/or a Bluetooth MAC address, and/or a WiFi MAC address, and/or the terminal frequency;

counting a number of received terminal MAC address, and/or a number of received Bluetooth MAC address, and/or a number of received WiFi MAC address, and/or a number of received terminal frequency, for obtaining a number information of a terminal in the detection area; determining a position information of the terminal according to the detection area, and estimating a number information and a position information of trapped people according to the number information and the position information of the terminal; and

sending, in real time, the number information and the position information of the trapped people to a safety director or a rescue worker.

Preferably, the step of detecting, in real time, a Bluetooth signal, and/or a WiFi signal, and/or a terminal frequency in a detection area, and obtaining a terminal MAC address, and/or a Bluetooth MAC address, and/or a WiFi MAC address, and/or the terminal frequency, further comprises:

outputting a guidance information for guiding the trapped people to escape, when the Bluetooth signal, and/or the WiFi signal, and/or the terminal frequency is detected in the detection area;

sending the terminal MAC address, and/or the Bluetooth MAC address, and/or the WiFi MAC address, and/or the terminal frequency to a cloud server.

Preferably, the step of counting a number of received terminal MAC address, and/or a number of received Bluetooth MAC address, and/or a number of received WiFi MAC address, and/or a number of received terminal frequency, for obtaining a number information of a terminal in the detection area; determining a position information of the terminal according to the detection area, and estimating a number information and a position information of trapped people according to the number information and the position information of the terminal, further comprises:

determining a movement direction and/or a movement area of the trapped people according to the position information of the terminal determined by at least twice detections, and further estimating the number information and the position information of the trapped people and determining a fire rescue scale according to the number information and the position information of the trapped people;

sending an alarm of a corresponding level to an alarm control center according to the fire rescue scale.

Preferably, the step of sending, in real time, the number information and the position information of the trapped people to a safety director or a rescue worker, further comprises:

generating a dynamic distribution map of the trapped people according to the number information and the position information of the trapped people combining with a structure diagram of the detection area;

sending the dynamic distribution map of the trapped people to the safety director or the rescue worker.

Preferably, the step of detecting, in real time, a Bluetooth signal, and/or a WiFi signal, and/or a terminal frequency in a detection area, and obtaining a terminal MAC address, and/or a Bluetooth MAC address, and/or a WiFi MAC address, and/or the terminal frequency, further comprises:

sending the terminal MAC address, and/or the Bluetooth MAC address, and/or the WiFi MAC address, and/or the terminal frequency, to a MAC server which obtains an information of the trapped people according to the terminal MAC address, and/or the Bluetooth MAC address, and/or the WiFi MAC address, and/or the terminal frequency.

In a second aspect, a monitoring system based on terminal detection is provided, which comprising a plurality of detection areas, a communication module and a control module, wherein the detection area is arranged with a plurality of detection modules; wherein

the detection module is used for detecting, in real time, a Bluetooth signal, and/or a WiFi signal, and/or a terminal frequency in the detection area, and obtaining a terminal MAC address, and/or a Bluetooth MAC address, and/or a WiFi MAC address, and/or the terminal frequency;

the control module is used for counting a number of received terminal MAC address, and/or a number of received Bluetooth MAC address, and/or a number of received WiFi MAC address, and/or a number of received terminal frequency, for obtaining a number information of a terminal in the detection area; determining a position information of the terminal according to the detection area, and estimating a number information and a position information of trapped people according to the number information and the position information of the terminal;

the communication module is used for sending the terminal MAC address, and/or the Bluetooth MAC address, and/or the WiFi MAC address, and/or the terminal frequency to the control module and sending, in real time, the number information and the position information of the trapped people to a safety director or a rescue worker.

Preferably, the monitoring system based on terminal detection further comprises a rescue guidance module and a cloud server; wherein

the rescue guidance module is used for outputting a guidance information for guiding the trapped people to escape, when the Bluetooth signal, and/or the WiFi signal, and/or the terminal frequency is detected in the detection area;

the communication module is further used for sending the terminal MAC address, and/or the Bluetooth MAC address, and/or the WiFi MAC address, and/or the terminal frequency to the cloud server.

Preferably, the detection area is arranged with an alarm module connected with the control module; wherein

the control module is used for determining a movement direction and/or a movement area of the trapped people according to the position information of the terminal determined by at least twice detections, and further estimating the number information and the position information of the trapped people and determining a fire rescue scale according to the number information and the position information of the trapped people;

the alarm module is used for sending an alarm of a corresponding level to an alarm control center according to the fire rescue scale.

Preferably, the control module is further used for generating a dynamic distribution map of the trapped people according to the number information and the position information of the trapped people combining with a structure diagram of the detection area;

the communication module is further used for sending the dynamic distribution map of the trapped people to the safety director or the rescue worker.

Preferably, the monitoring system based on terminal detection further comprises a MAC server; wherein

the communication module is further used for sending the terminal MAC address, and/or the Bluetooth MAC address, and/or the WiFi MAC address, and/or the terminal frequency, to the MAC server which obtains an information of the trapped people according to the terminal MAC address, and/or the Bluetooth MAC address, and/or the WiFi MAC address, and/or the terminal frequency.

By implementing the monitoring method and the monitoring system based on terminal detection according to the present disclosure, effective information can be provided for formulating the rescue plan and implementing the on-site control and rescue, the rescue risk can be reduced while the safety of the trapped people and the rescue workers can be guaranteed by obtaining the terminal MAC address, and/or the Bluetooth MAC address, and/or the WiFi MAC address, and/or the terminal frequency through one or more detection manner including detecting the Bluetooth unit, WiFi or terminal frequency in the detection area, further obtaining the position information and the number information of the terminal, estimating the number information and the position information of trapped people and sending, in real time, the number information and the position information of the trapped people to the safety director or the rescue worker. In addition, the fire rescue scale can be determined according to the number information and the position information of the trapped people and the alarm of the corresponding level can be sent to the alarm control center according to the fire rescue scale, such that the alarm situation can be reported accurately, which is convenient for the fire department, emergency department and other third-party public platforms to implement the rescue. The monitoring method and the monitoring system based on terminal detection according to the present disclosure can improve the speed and efficiency of the on-site rescue, thus guaranteeing the life safety.

### BRIEF DESCRIPTION OF THE DRAWINGS

FIG. 1 is a flow diagram of the monitoring method based on terminal detection according to a first embodiment of the present application.

FIG. 2 is a structure diagram showing functional modules of the monitoring system based on terminal detection according to a second embodiment of the present application.

FIG. 3 is a structure diagram showing functional modules of the monitoring system based on terminal detection according to a third embodiment of the present application.

### DETAILED DESCRIPTION OF THE PREFERRED EMBODIMENT

To make the object, the technical solution, and the advantage of the present application more clearly, the present application is further described in detail below with reference to the accompanying embodiments. It should be understood that the specific embodiments described herein are only used to explain the present disclosure and are not used to limit the same.

It should be noted that the data used in the description and claims of the present disclosure and the attached drawings can be exchanged in appropriate cases, so that the embodiments of the present disclosure described here can be implemented in order other than those illustrated or described here. Furthermore, the terms “comprised” and “arranged with” and any variation of them are intended to cover non exclusive inclusions.

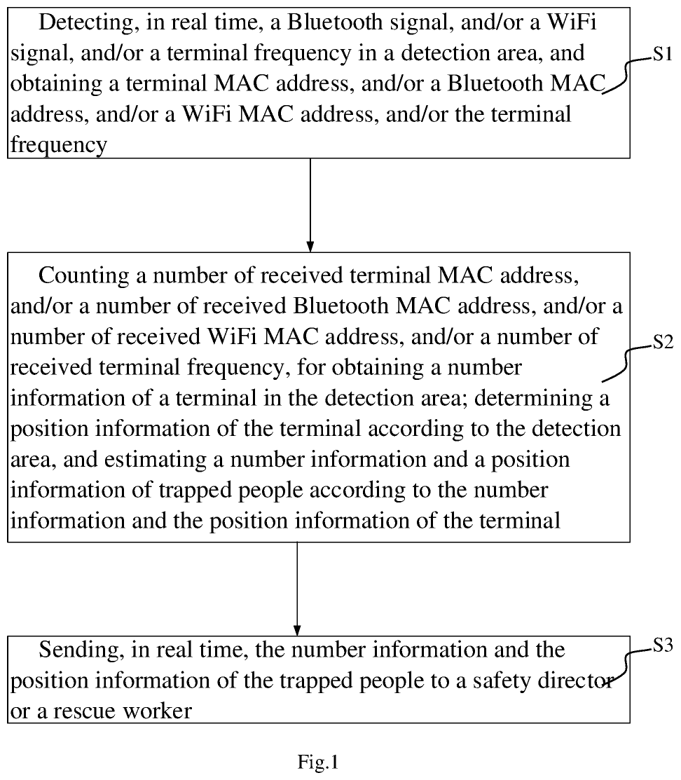

FIG. 1 is a flow diagram of the monitoring method based on terminal detection according to a first embodiment of the present application. As shown in FIG. 1, the monitoring method based on terminal detection can be applied to the fire alarm system, earthquake alarm system and other emergency rescue scenes, to quickly and accurately obtain the number information and the position information of the trapped person, provide the implementation basis for the rescue, reduce the rescue risk, and ensure the personal safety of the trapped person and rescue worker. The monitoring method based on terminal detection comprises the following steps.

In step S1, a Bluetooth signal, and/or a WiFi signal, and/or a terminal frequency in a detection area, is detected in real time for obtaining a terminal MAC address, and/or a Bluetooth MAC address, and/or a WiFi MAC address, and/or the terminal frequency.

In the step S1, the terminal is generally a mobile terminal with Bluetooth, WiFi, specific communication signal frequency or other wireless communication functions, such as a mobile phone, tablet computer, wearable intelligent device, etc. After the terminal turns on the Bluetooth, WiFi, specific communication signal frequency or other wireless communication functions, it can be detected and its MAC (media access control) address information can be obtained by parsing. The MAC address, also known as the physical address, hardware address or link address, is written in the terminal when it is produced by the network equipment manufacturer. This address has nothing to do with the network, that is, no matter at where the terminal with this address (such as network card, hub, router, etc.) is connected to the network, it has the same MAC address, that is, the terminal has a unique MAC address.

Furthermore, the step Si further comprises following steps.

In step S11, a guidance information for guiding the trapped people to escape is outputted, when the Bluetooth signal, and/or the WiFi signal, and/or the terminal frequency is detected in the detection area. The trapped people can be help to escape according to the guidance information, such as the indicator light, indicator voice, guidance video, etc., thus preventing the trapped people from choosing the wrong escape route due to confusion.

In step S12, the terminal MAC address, and/or the Bluetooth MAC address, and/or the WiFi MAC address, and/or the terminal frequency is sent to a cloud server. The terminal MAC address, and/or the Bluetooth MAC address, and/or the WiFi MAC address, and/or the terminal frequency is sent to the cloud server through a public network for further process, remote control and data backup.

In step S13, the terminal MAC address, and/or the Bluetooth MAC address, and/or the WiFi MAC address, and/or the terminal frequency is further sent to a MAC server which obtains an information of the trapped people according to the terminal MAC address, and/or the Bluetooth MAC address, and/or the WiFi MAC address, and/or the terminal frequency. As the terminal has the unique terminal MAC address, and/or Bluetooth MAC address, and/or WiFi MAC address, and/or terminal frequency, the user information of the terminal can be retrieved from the MAC server based on the received terminal MAC address, and/or Bluetooth MAC address, and/or WiFi MAC address, and/or terminal frequency, thus providing the specific information for the implementation of the rescue and improving the rescue efficiency.

In step S2, a number of received terminal MAC address, and/or a number of received Bluetooth MAC address, and/or a number of received WiFi MAC address, and/or a number of received terminal frequency, is counted for obtaining a number information of a terminal in the detection area, a position information of the terminal is determined according to the detection area, and a number information and a position information of trapped people are estimated according to the number information and the position information of the terminal.

In additional, the step S2 further comprises following steps.

In step S21, a movement direction and/or a movement area of the trapped people is determined according to the position information of the terminal determined by at least twice detections, the number information and the position information of the trapped people are estimated and then a fire rescue scale is determined according to the number information and the position information of the trapped people. By monitoring the movement direction and/or movement area of the terminal, the monitored accuracy of the number information and the position information of the trapped people can be improved. In additional, the prediction accuracy of the fire rescue scale can be improved.

In step S22, an alarm of a corresponding level can be sent to an alarm control center according to the fire rescue scale. The alarm can be accurately reported by implementing a grading alarm according to the fire rescue scale, it is convenient for the third-party public platform to take corresponding measures.

In step S3, the number information and the position information of the trapped people are sent to a safety director or a rescue worker in real time.

In additional, the step S3 further comprises following steps.

In step S31, a dynamic distribution map of the trapped people is generated according to the number information and the position information of the trapped people combining with a structure diagram of the detection area.

In step S32, the dynamic distribution map of the trapped people is sent to the safety director or the rescue worker.

The number information and the position information of the trapped people can be effectively indicated by generating the dynamic distribution map of the trapped people in real time, thus providing effective information to the third-party public platform for formulating the rescue plan and effectively guiding the rescue worker to rescue the trapped people, so as to improve the rescue speed and efficiency.

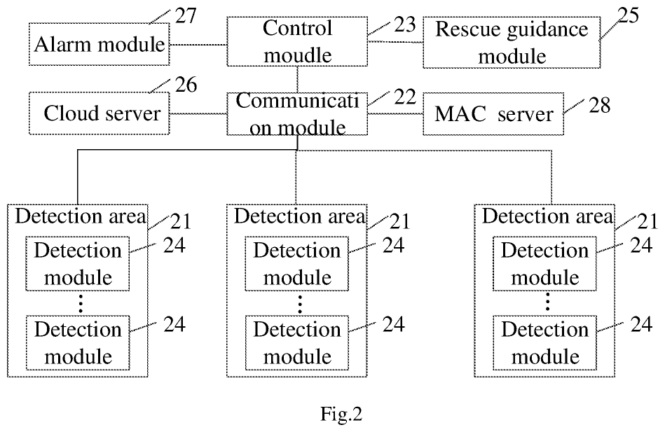

FIG. 2 is a structure diagram showing functional modules of the monitoring system based on terminal detection according to a second embodiment of the present application. As shown in FIG. 2, the monitoring system based on terminal detection can be applied to the fire alarm system, earthquake alarm system and other emergency rescue scenes, to quickly and accurately obtain the number information and the position information of the trapped person, provide the implementation basis for the rescue, reduce the rescue risk, and ensure the personal safety of the trapped person and rescue worker.

The monitoring system based on terminal detection according to the second embodiment of the present application, comprises a plurality of detection areas 21, a communication module 22 and a control module 23, wherein the detection area 21 is arranged with a plurality of detection modules 24.

The detection module 24 is used for detecting, in real time, a Bluetooth signal, and/or a WiFi signal, and/or a terminal frequency in the detection area 21, and obtaining a terminal MAC address, and/or a Bluetooth MAC address, and/or a WiFi MAC address, and/or the terminal frequency.

The control module 23 is used for receiving the terminal MAC address, and/or the Bluetooth MAC address, and/or the WiFi MAC address, and/or the terminal frequency, and counting a number of received terminal MAC address, and/or a number of received Bluetooth MAC address, and/or a number of received WiFi MAC address, and/or a number of received terminal frequency, for obtaining a number information of a terminal in the detection area 21; determining a position information of the terminal according to the detection area 21, and estimating a number information and a position information of trapped people according to the number information and the position information of the terminal.

The communication module 22 is used for sending the terminal MAC address, and/or the Bluetooth MAC address, and/or the WiFi MAC address, and/or the terminal frequency to the control module 23 and sending, in real time, the number information and the position information of the trapped people to a safety director or a rescue worker.

The monitoring system based on terminal detection according to the second embodiment of the present application, further comprises a rescue guidance module 25 and a cloud server 26.

The rescue guidance module 25 is used for outputting a guidance information for guiding the trapped people to escape, when the Bluetooth signal, and/or the WiFi signal, and/or the terminal frequency is detected in the detection area 21.

The communication module 22 is further used for sending the terminal MAC address, and/or the Bluetooth MAC address, and/or the WiFi MAC address, and/or the terminal frequency to the cloud server 26.

The monitoring system based on terminal detection according to the second embodiment of the present application, further comprises an alarm module 27 connected with the control module 23.

The control module 23 is used for determining a movement direction and/or a movement area of the trapped people according to the position information of the terminal determined by at least twice detections, and further estimating the number information and the position information of the trapped people and determining a fire rescue scale according to the number information and the position information of the trapped people.

The alarm module 27 is used for sending an alarm of a corresponding level to an alarm control center according to the fire rescue scale.

Preferably, the control module 23 in the monitoring system based on terminal detection according to the second embodiment of the present application, is further used for generating a dynamic distribution map of the trapped people according to the number information and the position information of the trapped people combining with a structure diagram of the detection area 21.

The communication module 22 in the monitoring system based on terminal detection according to the second embodiment of the present application, is further used for sending the dynamic distribution map of the trapped people to the safety director or the rescue worker.

The monitoring system based on terminal detection according to the second embodiment of the present application, further comprises a MAC server 28. The communication module 22 is further used for sending the terminal MAC address, and/or the Bluetooth MAC address, and/or the WiFi MAC address, and/or the terminal frequency, to the MAC server 28 which obtains an information of the trapped people according to the terminal MAC address, and/or the Bluetooth MAC address, and/or the WiFi MAC address, and/or the terminal frequency.

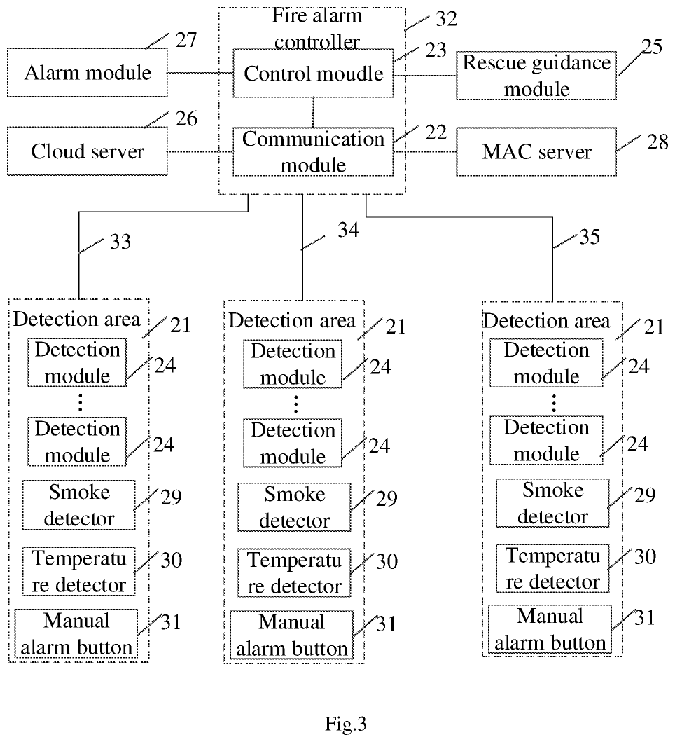

As shown in FIG. 3, a further monitoring system based on terminal detection is provided, which can be applied to the fire alarm system, earthquake alarm system and other emergency rescue scenes, to quickly and accurately obtain the number information and the position information of the trapped person, provide the implementation basis for the rescue, reduce the rescue risk, and ensure the personal safety of the trapped person and rescue worker.

The monitoring system based on terminal detection according to the third embodiment of the present application, comprises a fire alarm controller 32 and a detection area 21 respectively connected with the fire alarm controller 32 through a first loop 33, a second loop 34 and a third loop 35, wherein the fire alarm controller 32 comprises a communication module 22 and a control module 23. A plurality of detection modules 24 are arranged in the detection area 21. The detection module 24 is used for detecting, in real time, a Bluetooth signal, and/or a WiFi signal, and/or a terminal frequency in the detection area 21, and obtaining a terminal MAC address, and/or a Bluetooth MAC address, and/or a WiFi MAC address, and/or the terminal frequency.

The control module 23 is used for receiving the terminal MAC address, and/or the Bluetooth MAC address, and/or the WiFi MAC address, and/or the terminal frequency, and counting a number of received terminal MAC address, and/or a number of received Bluetooth MAC address, and/or a number of received WiFi MAC address, and/or a number of received terminal frequency, for obtaining a number information of a terminal in the detection area 21; determining a position information of the terminal according to the detection area 21, and estimating a number information and a position information of trapped people according to the number information and the position information of the terminal.

The communication module 22 is used for sending the terminal MAC address, and/or the Bluetooth MAC address, and/or the WiFi MAC address, and/or the terminal frequency to the control module 23 and sending, in real time, the number information and the position information of the trapped people to a safety director or a rescue worker.

The detection area of the monitoring system based on terminal detection according to the third embodiment of the present application, further comprises a smoke detector 29 for detecting smoke, a temperature detector 30 for detecting temperature, and a manual alarm button 31 for manually alarming.

The monitoring system based on terminal detection according to the third embodiment of the present application, further comprises a rescue guidance module 25 and a cloud server 26.

The rescue guidance module 25 is used for outputting a guidance information for guiding the trapped people to escape, when the Bluetooth signal, and/or the WiFi signal, and/or the terminal frequency is detected in the detection area 21.

The communication module 22 is further used for sending the terminal MAC address, and/or the Bluetooth MAC address, and/or the WiFi MAC address, and/or the terminal frequency to the cloud server 26.

The monitoring system based on terminal detection according to the third embodiment of the present application, further comprises an alarm module 27 connected with the control module 23.

The control module 23 is used for determining a movement direction and/or a movement area of the trapped people according to the position information of the terminal determined by at least twice detections, and further estimating the number information and the position information of the trapped people and determining a fire rescue scale according to the number information and the position information of the trapped people.

The alarm module 27 is used for sending an alarm of a corresponding level to an alarm control center according to the fire rescue scale.

Preferably, the control module 23 in the monitoring system based on terminal detection according to the third embodiment of the present application, is further used for generating a dynamic distribution map of the trapped people according to the number information and the position information of the trapped people combining with a structure diagram of the detection area 21.

The communication module 22 in the monitoring system based on terminal detection according to the third embodiment of the present application, is further used for sending the dynamic distribution map of the trapped people to the safety director or the rescue worker.

The monitoring system based on terminal detection according to the third embodiment of the present application, further comprises a MAC server 28. The communication module 22 is further used for sending the terminal MAC address, and/or the Bluetooth MAC address, and/or the WiFi MAC address, and/or the terminal frequency, to the MAC server 28 which obtains an information of the trapped people according to the terminal MAC address, and/or the Bluetooth MAC address, and/or the WiFi MAC address, and/or the terminal frequency.

By implementing the monitoring method and the monitoring system based on terminal detection according to the present disclosure, effective information can be provided for formulating the rescue plan and implementing the on-site control and rescue, the rescue risk can be reduced while the safety of the trapped people and the rescue workers can be guaranteed by obtaining the terminal MAC address, and/or the Bluetooth MAC address, and/or the WiFi MAC address, and/or the terminal frequency through one or more detection manner of detecting the Bluetooth unit, WiFi or terminal frequency in the detection area, further obtaining the position information and the number information of the terminal, estimating the number information and the position information of trapped people and sending, in real time, the number information and the position information of the trapped people to the safety director or the rescue worker. In addition, the fire rescue scale can be determined according to the number information and the position information of the trapped people and the alarm of the corresponding level can be sent to the alarm control center according to the fire rescue scale, such that the alarm situation can be reported accurately, which is convenient for the fire department, emergency department and other third-party public platforms to implement the rescue. The monitoring method and the monitoring system based on terminal detection according to the present disclosure can improve the speed and efficiency of the on-site rescue, thus guaranteeing the life safety.

Through the above description of the embodiments, one skilled in the art can clearly understand that the above embodiments can be realized by means of software plus necessary general hardware platform. Of course, they can also be realized by means of hardware, but in many cases, the former is a better embodiment. Based on this understanding, the technical solution of the present disclosure can be embodied in the form of software product, which is stored in a storage medium (such as ROM/RAM, magnetic disk, optical disk) and includes several instructions to make a terminal device (which can be a mobile phone, a computer, a server, a network device, etc.) to carry out the embodiment of the present disclosure.

Therefore, the above description is only a better specific embodiment of the present disclosure, and the protection scope of the present disclosure is not limited to this. Any modification or replacement that can be easily thought of by one skilled in the art within the technical scope of the disclosure shall be included in the protection scope of the present disclosure, and the protection scope of the present disclosure shall be subject to the protection scope of the claims.

1. A monitoring method based on terminal detection comprising following steps:
detecting, in real time, a Bluetooth signal, and/or a WiFi signal, and/or a terminal frequency in a detection area, and obtaining a terminal MAC address, and/or a Bluetooth MAC address, and/or a WiFi MAC address, and/or the terminal frequency;
counting a number of received terminal MAC address, and/or a number of received Bluetooth MAC address, and/or a number of received WiFi MAC address, and/or a number of received terminal frequency, for obtaining a number information of a terminal in the detection area; determining a position information of the terminal according to the detection area, and estimating a number information and a position information of trapped people according to the number information and the position information of the terminal; and
sending, in real time, the number information and the position information of the trapped people to a safety director or a rescue worker.

2. The monitoring method based on terminal detection according to claim 1, wherein the step of detecting, in real time, a Bluetooth signal, and/or a WiFi signal, and/or a terminal frequency in a detection area, and obtaining a terminal MAC address, and/or a Bluetooth MAC address, and/or a WiFi MAC address, and/or the terminal frequency, further comprises:
outputting a guidance information for guiding the trapped people to escape, when the Bluetooth signal, and/or the WiFi signal, and/or the terminal frequency is detected in the detection area;
sending the terminal MAC address, and/or the Bluetooth MAC address, and/or the WiFi MAC address, and/or the terminal frequency to a cloud server.

3. The monitoring method based on terminal detection according to claim 1, wherein the step of counting a number of received terminal MAC address, and/or a number of received Bluetooth MAC address, and/or a number of received WiFi MAC address, and/or a number of received terminal frequency, for obtaining a number information of a terminal in the detection area; determining a position information of the terminal according to the detection area, and estimating a number information and a position information of trapped people according to the number information and the position information of the terminal, further comprises:
determining a movement direction and/or a movement area of the trapped people according to the position information of the terminal determined by at least twice detections, and further estimating the number information and the position information of the trapped people and determining a fire rescue scale according to the number information and the position information of the trapped people;
sending an alarm of a corresponding level to an alarm control center according to the fire rescue scale.

4. The monitoring method based on terminal detection according to claim 3, wherein the step of sending, in real time, the number information and the position information of the trapped people to a safety director or a rescue worker, further comprises:
generating a dynamic distribution map of the trapped people according to the number information and the position information of the trapped people combining with a structure diagram of the detection area;
sending the dynamic distribution map of the trapped people to the safety director or the rescue worker.

5. The monitoring method based on terminal detection according to claim 1, wherein the step of detecting, in real time, a Bluetooth signal, and/or a WiFi signal, and/or a terminal frequency in a detection area, and obtaining a terminal MAC address, and/or a Bluetooth MAC address, and/or a WiFi MAC address, and/or the terminal frequency, further comprises:
sending the terminal MAC address, and/or the Bluetooth MAC address, and/or the WiFi MAC address, and/or the terminal frequency, to a MAC server which obtains an information of the trapped people according to the terminal MAC address, and/or the Bluetooth MAC address, and/or the WiFi MAC address, and/or the terminal frequency.

6. A monitoring system based on terminal detection comprising a plurality of detection areas, a communication module and a control module, wherein the detection area is arranged with a plurality of detection modules; wherein
the detection module is used for detecting, in real time, a Bluetooth signal, and/or a WiFi signal, and/or a terminal frequency in the detection area, and obtaining a terminal MAC address, and/or a Bluetooth MAC address, and/or a WiFi MAC address, and/or the terminal frequency;
the control module is used for counting a number of received terminal MAC address, and/or a number of received Bluetooth MAC address, and/or a number of received WiFi MAC address, and/or a number of received terminal frequency, for obtaining a number information of a terminal in the detection area; determining a position information of the terminal according to the detection area, and estimating a number information and a position information of trapped people according to the number information and the position information of the terminal;
the communication module is used for sending the terminal MAC address, and/or the Bluetooth MAC address, and/or the WiFi MAC address, and/or the terminal frequency to the control module and sending, in real time, the number information and the position information of the trapped people to a safety director or a rescue worker.

7. The monitoring system based on terminal detection according to claim 6, wherein the monitoring system based on terminal detection further comprises a rescue guidance module and a cloud server; wherein
the rescue guidance module is used for outputting a guidance information for guiding the trapped people to escape, when the Bluetooth signal, and/or the WiFi signal, and/or the terminal frequency is detected in the detection area;
the communication module is further used for sending the terminal MAC address, and/or the Bluetooth MAC address, and/or the WiFi MAC address, and/or the terminal frequency to the cloud server.

8. The monitoring system based on terminal detection according to claim 6, wherein the detection area is arranged with an alarm module connected with the control module; wherein
the control module is used for determining a movement direction and/or a movement area of the trapped people according to the position information of the terminal determined by at least twice detections, and further estimating the number information and the position information of the trapped people and determining a fire rescue scale according to the number information and the position information of the trapped people;
the alarm module is used for sending an alarm of a corresponding level to an alarm control center according to the fire rescue scale.

9. The monitoring system based on terminal detection according to claim 8, wherein
the control module is further used for generating a dynamic distribution map of the trapped people according to the number information and the position information of the trapped people combining with a structure diagram of the detection area;
the communication module is further used for sending the dynamic distribution map of the trapped people to the safety director or the rescue worker.

10. The monitoring system based on terminal detection according to claim 6, wherein the monitoring system based on terminal detection further comprises a MAC server; wherein the communication module is further used for sending the terminal MAC address, and/or the Bluetooth MAC address, and/or the WiFi MAC address, and/or the terminal frequency, to the MAC server which obtains an information of the trapped people according to the terminal MAC address, and/or the Bluetooth MAC address, and/or the WiFi MAC address, and/or the terminal frequency.
